(19) United States
(12) Patent Application Publication
(10) Pub. No.: US 2013/0000252 A1
(43) Pub. Date: Jan. 3, 2013

(54) CREATING ON-DEMAND PACKAGING BASED ON CUSTOM ARRANGEMENT OF ITEMS

(75) Inventors: Niklas Pettersson, Sandy, UT (US); Ryan Osterhout, West Haven, UT (US)

(73) Assignee: PACKSIZE, LLC, Salt Lake City, UT (US)

(21) Appl. No.: 13/514,335

(22) PCT Filed: Dec. 10, 2010
(86) PCT No.: PCT/US10/59942

§ 371 Date: Sep. 11, 2012

Related U.S. Application Data
(60) Provisional application No. 61/285,962, filed on Dec. 12, 2009.

(51) Int. Cl. B65B 57/00; H04N 13/02; H04N 7/18

(52) U.S. Cl. 53/396; 348/135; 348/46; 53/52; 348/E07.085; 348/E13.074

(57) ABSTRACT

Methods, apparatus, assemblies, and systems relate to producing on-demand packaging. For example, packaging can be automatically produced on-demand and be sized and configured for use with a customized set of items and/or a customized arrangement of items. In one aspect, items are arranged on a resting device and an imaging component obtains image or other data related to such arrangement. Based on the image, dimensions of the arrangement may be determined and a packaging template, such as a box template, may be designed. The designed template may have dimensions suitable to enclose the items when arranged in the manner provided on the resting device. A packaging production machine may produce a box template, on-demand, after the box template has been designed based on the physical arrangement of items on the resting device.

### RELATED APPLICATIONS

This application claims priority to, and the benefit of, U.S. Patent Application Ser. No. 61/285,962 filed on Dec. 12, 2009, and entitled “CREATING ON-DEPAND PACKAGING BASED ON MANUAL ARRANGEMENT OF ITEMS” which application is expressly incorporated herein by this reference in its entirety.

### BACKGROUND

With the increasing availability of merchandise, products, and other items not only locally, but through a global market, the need to properly and efficiently package such materials for shipment and delivery has never been more important. Products that are improperly packaged are more likely to be damaged on arrival, which can result in a significant cost to the provider if the product needs to be returned, replaced, or even if a frustrated consumer decides simply to cancel a purchase. Fortunately, available packaging systems can now be used to produce virtually any style of packaging, including packaging that can safely enclose and store one or more products.

Perhaps the single biggest factor in producing packaging for a product is that the packaging be designed to fit the contained product as precisely as possible. With a more precise fit, the contained item or product not only is less likely to be damaged, but the need for inner packaging is also reduced and possibly eliminated. In particular, when packaging materials (e.g., corrugated cardboard, paper, etc.) are used to create a box or other packaging design, the materials are often creased and folded as near to a right angle possible. Creasing and folding at right angles increases strength characteristics of the packaging materials, thereby giving a resulting box a correspondingly increased resistance to damage when stacked.

A standard box has twenty-four right angles making up its rectilinear form. If one or more angles deviate from a right angle by more than even a few degrees, other angles can also be comprised and the strength of a resulting box reduced. When strength decreases, the risk of damage or loss to the enclosed item(s) increases. Likewise when packaging fits loosely, similar risks of damage or loss can occur as the sides of the packaging can bow, the corners may sag, and the right angles that make the package strong may be lost.

Using boxes or other packaging that provide a more precise fit can thus provide a dramatic reduction in loss and damage. A more precise fit also produces other significant savings, such as, for example, reducing in the amount of material used in producing a box, reducing and potentially eliminating inner packaging, reducing postage and handling fees, reducing time at the pack line, and increasing transportation yield.

Existing packaging equipment permits a manufacturer, producer, or vendor to key in a desired box template or potentially the desired dimensions of a box or other package. The equipment can then automatically generates a box template with appropriate cuts and creases. For high volume items box sizes are often pre-selected and pre-fabricated since repeated sales and/or storage of such items makes it economically feasible to design a package specific to such item or collection of items.

However, it is often not feasible to pre-select box sizes and/or pre-fabricate boxes for low volume items, specialty items, unique arrangements of items, etc., at least not in a manner that provides a precise fit. For example, a retailer operating an online store may have thousands of different items, and could receive an order for any number of different items, such that the combined size, shape, weight, and other configuration of a desired package would be virtually impossible to predict beforehand. Such combinations have heretofore made it difficult to produce customized packaging economically, due at least in part to the time needed to arrange and measure the items, and key in a box size for each order that includes multiple items. Thus, retailers have generally been forced to choose select a box from available boxes of standard sizes and fill in the gaps within the box with internal packaging materials.

### BRIEF SUMMARY

Embodiments of the present disclosure are directed to a system for creating on-demand packaging based on a physical arrangement of items to be placed within the created packaging. Embodiments of the present disclosure include systems, machines, methods, assemblies, and computer-readable media usable to efficiently and automatically produce customized packaging for a wide variety of combinations of different items and products.

According to one example embodiment, a system is disclosed for arranging, measuring, and/or packaging items. An exemplary system may include a resting element configured to receive and stabilize an arrangement of one or more physical items. The resting element may include a base surface on which the items are arranged. The system may also include an imaging component. The imaging component may be configured to obtain dimensional information based on a size of the arrangement of items stabilized by the resting element.

In accordance with an aspect that may be combined with any other aspect herein, the resting device may also include at least one side surface connected to the base surface. The side surface and base surface may be oriented relative to an origin. In some cases, there may be two side surfaces connected to the base surface and oriented relative to the origin.

In accordance with an aspect that may be combined with any other aspect herein, the imaging component may obtain dimensional information relative to the origin defined by one or more planes or surfaces.

In accordance with an aspect that may be combined with any other aspect herein, one or more side surfaces of a resting device are generally perpendicular to the base surface of the resting device. The base surface and one or more side surfaces may intersect at an origin.

In accordance with an aspect that may be combined with any other aspect herein, the base surface is inclined in one direction. In some embodiments, the base surface is inclined in two directions. For instance, the base surface may be inclined in one or two directions towards an origin.

In accordance with an aspect that may be combined with any other aspect herein, an imaging component obtains three-dimensional information. For instance, the imaging component may obtain images or other type of scan data. According to one aspect, the image component is a three-dimensional scanner such as a time of flight camera.

In accordance with an aspect that may be combined with any other aspect herein, the imaging component communicates with a packaging production machine. The imaging component may transmit dimensional information about an arrangement of items to the packaging production machine so as to allow the packaging production machine to design and/or dynamically produce packaging sized to fit the arrangement of items.

In accordance with an aspect that may be combined with any other aspect herein, a processing component may be used to connect the imaging component to the packaging production machine. The packaging production machine and/or the processing component may, upon obtaining image data or dimensional data, design a packaging template having an interior size generally corresponding to the dimensions of the arrangement of items.

In accordance with another aspect that may be combined with any other aspect herein, a method is disclosed for creating customized packaging on demand and based on a size of physical items for placement in the customized packaging. The method may include determining that one or more items have been placed into an arrangement, obtaining image data of said arrangement, the image data representing three-dimensional size information, and in response to obtaining the image data, automatically and/or dynamically designing a package template having an interior capacity generally corresponding to the three-dimensional size information.

In accordance with an aspect that may be combined with any other aspect herein, obtaining image data may include using a three-dimensional scanner to obtain images of an arrangement of items on a resting device.

In accordance with an aspect that may be combined with any other aspect herein, a processing component uses the image data to compute three-dimensional size information.

In accordance with an aspect that may be combined with any other aspect herein, a packaging production machine produces the dynamically designed package template from packaging materials.

In accordance with an aspect that may be combined with any other aspect herein, obtaining image data of an arrangement of items includes displaying a user interface. The user interface displays a visual representation of image data and/or three-dimensional size information.

In accordance with an aspect that may be combined with any other aspect herein, a user interface includes an input allowing selection of size information, initiation of obtaining dimensional or image data, sending of automatically determined dimensional information or template design information to a packaging production machine, or any combination of the foregoing.

In accordance with still another embodiment, a system for measuring an arrangement of items for dynamic design and creation of a customized package is disclosed. Such a system may include a resting device configured to receive an arrangement of physical items. An imaging component is included and configured to obtain image data of the arrangement of items, and a processing component may be operably coupled to the imaging component to use the image data in obtaining dimensional information related to the arrangement of said plurality of physical items. The processing component may be integral with, or separate from, the imaging component.

In accordance with an aspect that may be combined with any other aspect herein, a packaging production machine is configured to receive dimensional information from a processing component and use the dimensional information in dynamically producing a packaging template of a size corresponding to said dimensional information.

In accordance with an aspect that may be combined with any other aspect herein, the packaging production machine or processing component automatically, and without user input of dimensional information, designs a packaging template that can be assembled to have an interior size and shape generally corresponding to the size of the arranged physical items.

One embodiment includes creating customized, on-demand packaging. One or more items that are to be included in a box or other package are identified and placed in an arrangement. For example, items may be arranged at a specific location. The specific location may be a resting device, or may be any other location, such as a location usable with a calibrated imaging component. The arrangement of items may be analyzed by, for instance, obtaining dimensional information of the arrangement, or otherwise obtaining image data related to the arrangement. The dimensional data may be used to determine the size of packaging that should be created for the arrangement. The packaging may have a custom size suitable to enclose the arrangement of items, and may be created on-demand, in response to obtaining of the dimensional data. After determining the size of the packaging, a package template may be produced, assembled, and packed with the items. Such produced packaging may be produced without manual input of measurements of the size of the arranged items.

When items are arranged, a three-dimensional analysis of the item arrangement may be performed, and the three dimensional analysis may be used to determine the size of packaging that should be used for the arrangement. The packaging may have a custom size suitable to enclose the arrangement of items, and may be created on-demand. After determining the size of the packaging, a package template may be produced, assembled, and packed with the arranged items.

In some embodiments, the three dimensional analysis may include, or result in, dimensions of the arrangement being calculated. Such calculated dimensions may result from analyzing image data and can form the basis of a box or other packaging template design that can be produced to enclose the arranged items. Determining that the objects have been placed in an arrangement and performing the three-dimensional analysis may be performed by a measurement component and/or a processing component. An example measurement component may be, for example, a three-dimensional scanner such as a time-of-flight scanner. A processing component may include a processor that executes computer-executable instructions that analyze information obtained from the measurement component.

An arrangement of items may be made manually, robotically, virtually, or in any other manner. For example, an arrangement may be made by physically placing each of a set of to-be-packaged items on a resting device accessible to a measurement component that obtains dimensional and/or image data.

An example resting device may be a table or other horizontal, inclined, or otherwise oriented surface. In some cases, the resting device may define an origin. For example, three planes angularly offset from each other at right angles may define the origin. A base plane of the three planes may be flat and/or set at an incline. For example, the base plane may be sloped so that one or more edges of the base plane are positioned lower relative to an opposing edge. In another embodiment, the bottom plane may slope in multiple directions. For example, the origin may be positioned lower or higher relative to exterior edge surfaces of the base plane.

The system may interact with a packaging production machine that creates box templates of a custom size. For example, a processing component may communicate with the packaging production machine to automatically supply dimensional information that the packaging production machine uses to design a packaging template. The box template may be sized to enclose the arrangement of items on the resting device, and the packaging production machine may automatically determine what cuts, creases, scores, perforations, or other features are to be made for production of the packaging template. Such a design may also be produced based on considerations for optimizing the packaging design, and can include material costs, size of the packaging materials (e.g., fanfold corrugated board) available, time needed to produce the template, and/or other preferred requirements. A display may also be included within the system and provide indicia to an operator of the system. In one example, the processing component may cause the display to show a graphical or visual representation of the arrangement of items, the dimensions of the arrangement, or other aspects. The display may also include an input for selection to initiate the automatic calculation of the dimensions of an arrangement and/or the creation of a packaging template.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages of the embodiments disclosed herein will be set forth in the description which follows, and in part will be obvious from the description, or may be learned by the practice of the embodiments disclosed herein. The features and advantages of the disclosed embodiments and variations thereof may be realized and obtained by means of the instruments and combinations particularly pointed out in the appended claims. These and other features of the present disclosure will become more fully apparent from the following description and appended claims, or may be learned by the practice of the embodiments as set forth hereinafter.

### BRIEF DESCRIPTION OF THE DRAWINGS

To further clarify various aspects of embodiments of the present disclosure, a more particular description of various features and aspects will be rendered by reference to specific embodiments thereof which are illustrated in the appended drawings. It is appreciated that these drawings depict only typical embodiments of the disclosure and are therefore not to be considered limiting of its scope, nor are the figures necessarily drawn to scale. The embodiments herein will be described and explained with additional specificity and detail through the use of the accompanying drawings in which:

FIG. 1 schematically illustrates a system architecture including a measurement system and a packaging production machine;

FIGS. 2A-2C illustrate an example measurement system usable in the system architecture of FIG. 1;

FIG. 3 illustrates a flow chart of a method of producing a customized package for an assortment of items;

FIG. 4 illustrates an assortment of items that may be arranged for the production and design of a customized package;

FIGS. 5A-5C illustrate various example embodiments of arrangements of the items in FIG. 4;

FIGS. 6A and 6B illustrate a box template that may be produced to contain the arrangement of items in FIG. 5A;

FIGS. 7A and 7B illustrate a box template that may be produced to contain the arrangement of items in FIG. 5B; and

FIGS. 8A and 8B illustrate a box template that may be produced to contain the arrangement of items in FIG. 5C.

### DETAILED DESCRIPTION OF SOME EXAMPLE EMBODIMENTS

Example embodiments of the present disclosure are directed to a system for creating on-demand packaging. More particularly, exemplary embodiments of the present disclosure are directed to systems, machines, assemblies, and computer-readable media usable to efficiently and automatically produce customized packaging for a wide variety of combinations of different items and products. Accordingly, example embodiments of the present disclosure may be utilized to efficiently produce packaging on-demand. For instance, such packaging may be customized for unique combinations of items in a manner that reduces the likelihood of damage or loss to the items, reduces consumption of packaging materials or supplies, reduces handling costs, reduces packaging time, or provides any of a number of other benefits, or any combination of the foregoing.

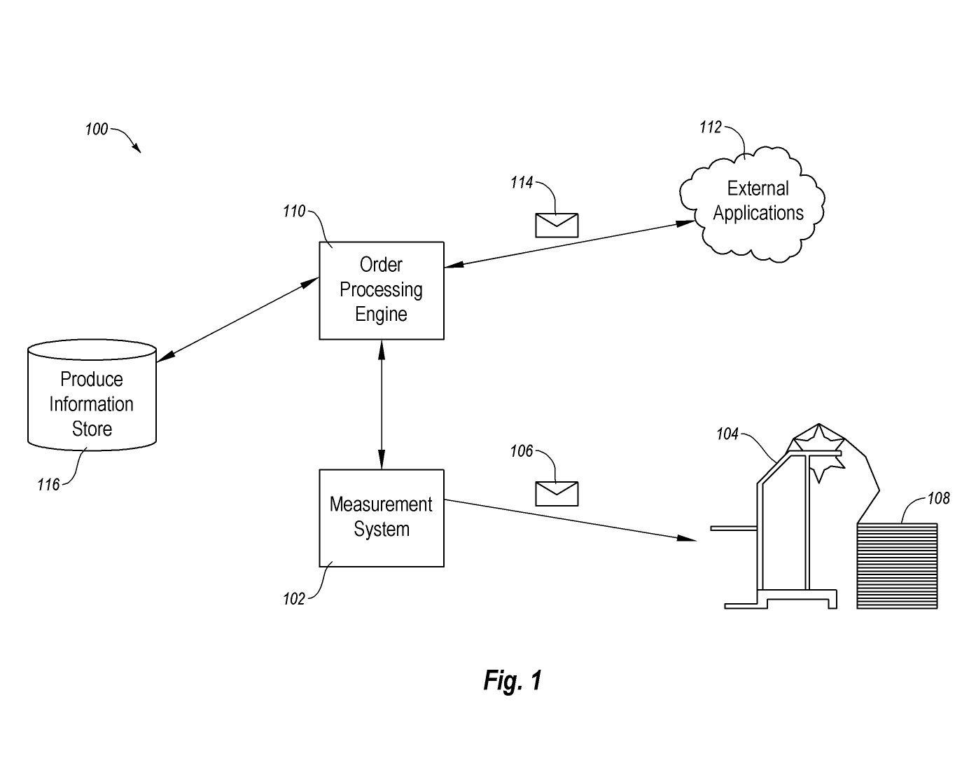

With reference now to FIG. 1, one example embodiment of an on-demand packaging system 110 is illustrated, and includes a measurement system 102 communicatively coupled to a packaging production machine 104. As described in further detail herein, one example of a measurement system 102 can receive an arrangement of one or more items. Based on the arrangement of such items, measurement system 102 can measure or otherwise obtain the dimensional information related to the items. Such dimensional information is optionally sent to a packaging production machine 104, such as by sending an electronic message 106. Upon receiving such a message 106, packaging production machine 104 may then use the received dimensional information to design and/or produce a template for a box or other package that may be used to contain the items when placed in the arrangement for which measurements were obtained by measurement system 102.

An example of packaging production machine 104 may be a box production machine that can receive dimensions and automatically design a box template that is cut, creased, scored, etc. to provide the dimensions provided by measurement system 102 when the box template is assembled. For example, packaging production machine 104 may access packaging materials 108 (e.g., endless materials such as fanfold-type corrugated board or rolls of corrugated board) and cut, crease, score, perforate, or otherwise manipulate the materials, or perform any combination of the foregoing, to produce a box or package template of a particular size and shape. The box or other package template may then be assembled and the items that were previously measured using measurement system 102 may be inserted inside the assembled box.

The foregoing description is exemplary only, and in other embodiments, packaging production machine 104 and/or measurement system 102 may have other functions or capabilities beyond those described herein. For example, packaging production machine 104 may essentially be any type of machine that can be used to dynamically produce packaging components of one or more different sizes and/or configurations. By way of illustration, packaging production machine 104 need not necessarily have the capability of automatically designing a box template. Instead, measurement system 102 may design a box template and send message 106 or otherwise communicate with packaging production machine 104 such that the packaging production machine 104 is provided with the design of a completed box or other package template.

As further illustrated in FIG. 1, on-demand packaging system 100 is optionally configured to operate as an order processing and/or product fulfillment system. According to one example embodiment, on-demand packaging system 100 is utilized in connection with a retailer or manufacture that provides one or more different products, although on-demand packaging system 100 may be used in any number of other areas, including in storage facilities. For example, a retailer or manufacturer may receive an order for one or more products at an order processing engine 110. By way of illustration, a consumer at a retail or online store may request a certain quantity of products. A salesman or order processing clerk may enter the purchase information directly into order processing engine 110, or into one of the external applications 112 which may then communicate the information to order processing engine 112. Such information may be communicated using an electronic message 114, or in any other suitable manner. In another example, a customer may enter purchase information directly, such as by using a web browser or other application 112 on a computing device that is connected by the Internet or another network to order processing engine 110.

Regardless of the manner of receipt of the order information, order processing engine 110 may receive a request indicating that one or more items have been ordered by a consumer and are to be stored and/or delivered to such consumer. Upon receiving an order or other item request, order processing engine 110 optionally accesses a product information store 116 that stores pricing information, availability, shipping costs, or other information associated with such products, or any combination of the foregoing. Order processing engine 110 can also optionally communicate information it has received from the product information store to the consumer, salesman, or some other identified entity. For example, order processing engine 110 may print a receipt for the consumer, or may sent a receipt to the consumer, thereby providing an order summary, invoice, delivery tracking information, or the like, any of which may include information retrieved from product information store 116. While the product information store 116 is illustrated as being separate from order processing engine 110, it should be appreciated that this is merely exemplary. In other embodiments, product information store 116 may be integral within order processing engine 110 and/or external applications 112.

According to one embodiment, after order processing engine 110 has received an order for one or more items, order processing engine 110 communicates with measurement system 102 or some other shipping fulfillment component to indicate that packaging for the ordered items is needed or requested. For example, order processing engine 110 may send notice of the order to measurement system 102 at the time the order is received, at the time the ordered items have been pulled and are ready for packaging, or at any other suitable time. In other embodiments, measurement processing engine 102 may communicate with external applications 112, or with a shipping or other order fulfillment component (not shown) rather than with order processing engine 110. In other embodiments, measurement system 102 may be detached entirely from order processing engine 110 and may be a stand-alone device or system that is manually made aware that a package is desired.

Regardless of the particular manner in which measurement system 102 is made aware of the need or desire for a package, items ordered or otherwise requested may be obtained and gathered for shipment. As described in greater detail herein, the to-be-packaged items may be physically arranged in one or more custom arrangements. Arrangements may be done manually by a person working on a packing line, may be performed in an automated fashion (e.g., using robotic arms), or in any other suitable manner. Upon any such arrangement, measurement system 102 can measure the custom arrangement or obtain information used to measure or obtain dimensional information related to the custom arrangement. Dimensional information may then be used by measurement system 102, packaging production machine 104, or another suitable component to design, calculate, or select a box or other packaging template that is to be produced by packaging production machine 104.

While on-demand packaging system 100 has been discussed primarily with reference to satisfying a customer order, it should be appreciated in view of the disclosure herein that this is merely exemplary, and that in other embodiments measurement system 102 may operate without any order being placed. For example, measurement system 102 may receive information about a variety of objects that the owner or operator of system 100 desires to store, package, or ship, independent of any particular order. Indeed, system 100 may be used to produce customized packaging of any type, including in response to determining which items are to be packaged and/or how a collection of one or more items is to be arranged within the package, regardless of the reason such packaging is requested.

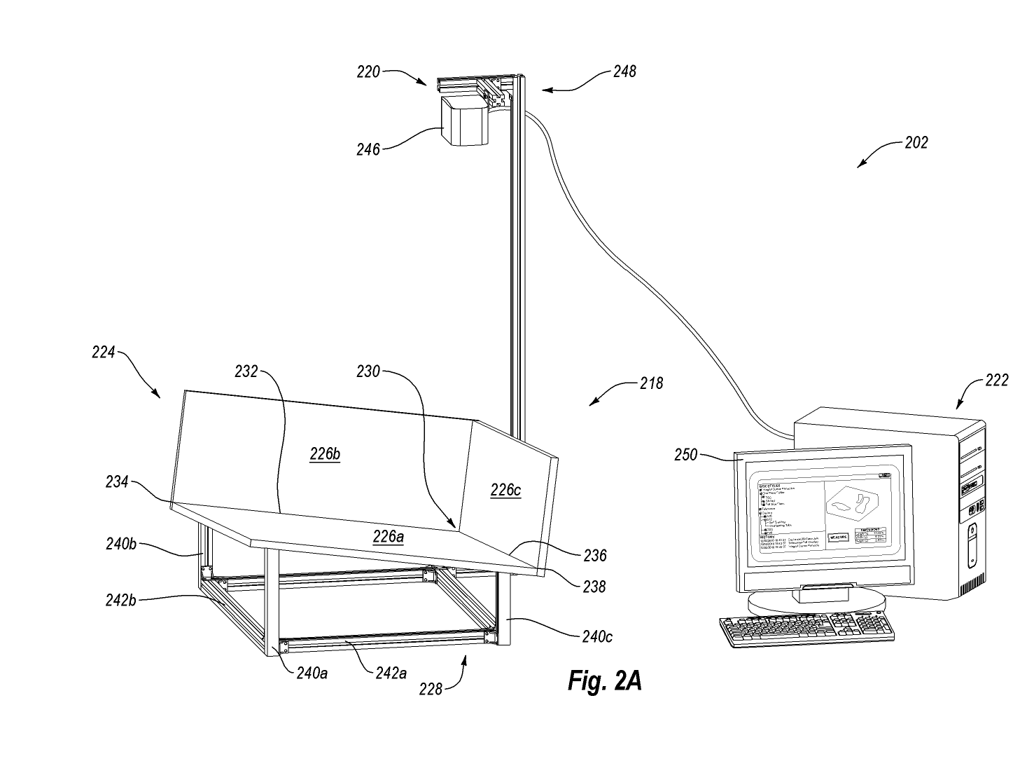

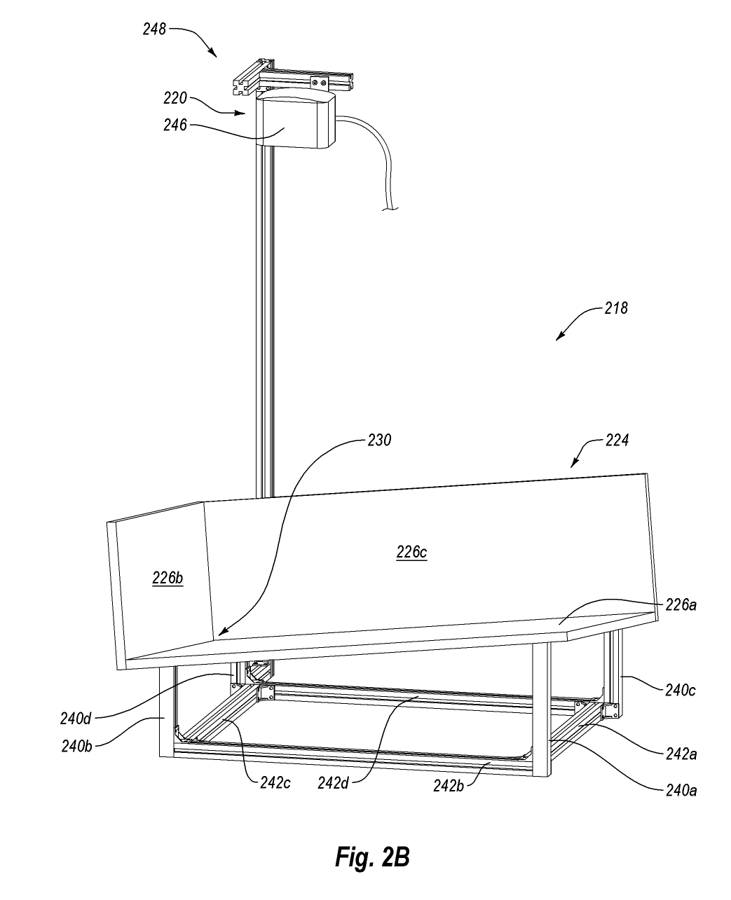

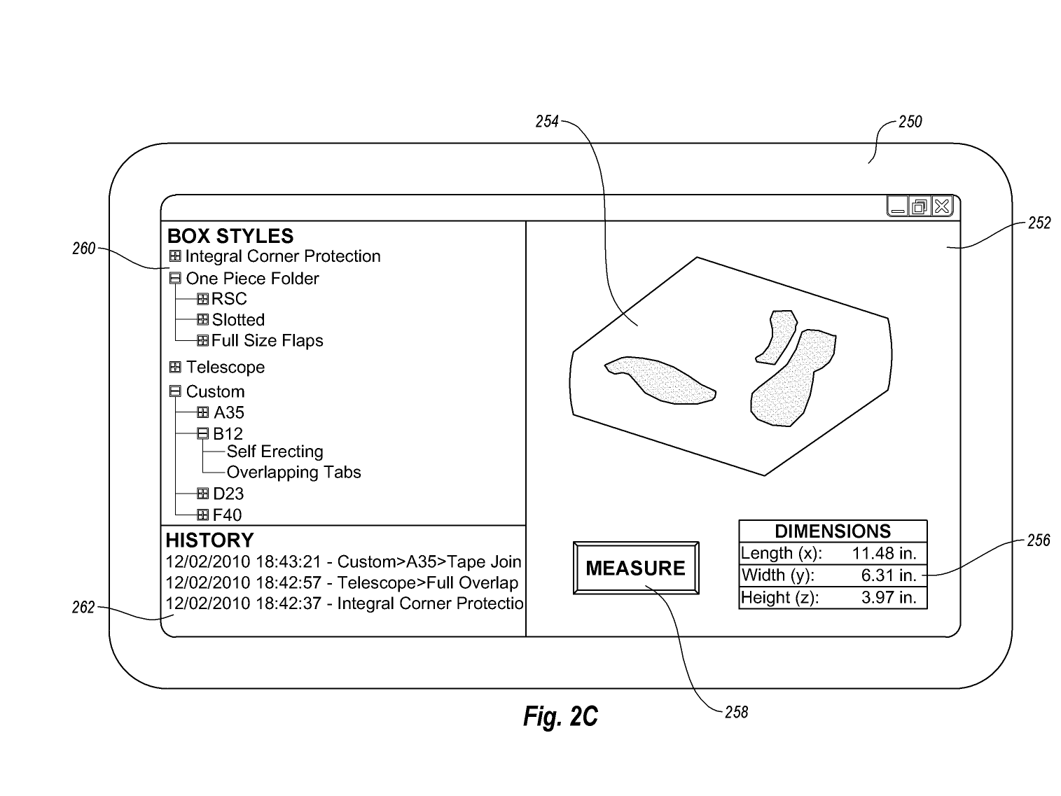

Turning now to FIGS. 2A and 2B, a particular example of a measurement system 202 is disclosed. Measurement system 202 is provided as merely one embodiment of a suitable measurement system that may, for instance, be used in connection with on-demand packaging system 100 of FIG. 1. It will be appreciated, however, that measurement system 202 of FIG. 2 is merely one example embodiment of an apparatus suitable in connection with the systems, assemblies, and devices of the present disclosure.

Measurement system 202 in the illustrated embodiment includes an arrangement component 218, a measurement component 220, and a processing component 222. By way of illustration, arrangement component 218 may be used to facilitate manual or other placement of one or more to-be-packaged items in a customized arrangement. Based on such an arrangement of items, measurement component 220 may measure, calculate, or otherwise determine dimensional information related to such an arrangement. For instance, measurement component 220 may obtain length, width, and height information that can be used to determine the size of an interior cavity of a customized package that can contain the arrangement. Optionally, processing component 222 receives the dimensions and/or provides a graphical interface. Such an interface may include, for instance, the dimensional information obtained by measurement component 220 and/or an illustration or image of the arrangement. In some embodiments, processing component 222 may also facilitate sending of the dimensional information obtained by or with the assistance of measurement component 220. For instance, processing component 222 may send the dimensional information to a packaging production machine, or perform any other suitable function.

According to one embodiment, arrangement component 218 generally provides a structure for arranging items so as to permit measurement component 220 to accurately obtain dimensional information of items placed on or within arrangement component 218, or otherwise associated therewith. Arrangement component 218 may take any number of suitable forms to allow such use. For example, in one embodiment, an arrangement component may be a flat surface such as a table or floor, on which items are arranged. In another embodiment, an arrangement component may be a box into which such items are arranged.

In the example embodiment in FIGS. 2A and 2B, arrangement component 218 includes at least three planes defining a three-plane resting device 224. In accordance with some embodiments of the present disclosure, three-plane resting device 224 includes a set of three planes 226a-c attached to a support structure 228. In the illustrated example of resting device 224, three planes 226a-c are arranged at approximately ninety-degree angles relative to each other, such that each of planes 226a-c is generally perpendicular relative to each other plane 226a-c. Planes 226a-c also, in this example embodiment, intersect at an origin 230. Origin 230 may provides a base location from which measurements of a customized arrangement of items may be made.

As described in greater detail hereafter, one or more items that are to be arranged using three-plane resting device 224 and optionally packaged, may be placed on resting device 224. Such items, once arranged, may also be secured in place. For example, an item may be placed on bottom plane 226a, and positioned adjacent origin 230 such that the item also engages each of side planes 226b, 226c. Of course, items may be arranged such that any particular item engages only one, two, or none of planes 226a-c. For example, an item may be placed on and between other items so as not to engage any of planes 226a-c. In general however, the assortment of items arranged on arrangement component 218 will collectively engage bottom surface 226a, as well as one or both of side planes 226b, 226c.

In general, arrangement component 218 provides a stable base on which items can be arranged and re-arranged. By way of illustration, one item may be positioned on arrangement component 218 near origin 230. If multiple items are to be packaged, each of the multiple items may be manually or otherwise arranged using arrangement component 218 so that the collective, custom arrangement of the items is supported by planes 226a-c. The planes 226a-c may also facilitate holding or otherwise securing the custom arrangement of items in place as well. Thus, arrangement component 218 is one example of a means for supporting a custom arrangement of unpackaged items.

To further facilitate arranging the items on arrangement component 218, one or more of planes 226a-c may, as shown in the illustrated embodiment, be set at an incline. More particularly, support structure 228 may facilitate placement of arrangement component 218 on a supporting surface such as floor, table, counter, or any other suitable surface. Such surface may be generally horizontal. With respect to such horizontal supporting surface, planes 226a-c are, in FIG. 2A shown as being inclined from left to right, such that an interface 232 between bottom plane 226a and side plane 226b inclines downward from left to right. Thus, in the illustrated embodiment, origin 230 on interface 232 may be at a lower position relative to a distal end 234 of interface 232. The amount of the incline between origin 230 and distal corner 234 may vary. For example, in one embodiment, the angle of incline is about fifteen degrees, although such incline may be more (e.g., between about fifteen and forty degrees) or less (e.g., between about zero and fifteen degrees).

An incline of one or more of planes 226a-c, while optional, allows three-plane resting device 224 of arrangement component 218 to make use of gravity to position and secure items in a particular arrangement. For example, gravity may act against an item placed on bottom surface 226a of three-plane resting device 224 to cause the item to slide towards side plane 226c. In some embodiments, an interface 236 between side plane 226c and bottom plane 226a is also inclined. For instance, the origin 230 may intersect interface 236 and be at a position that is lower relative to a distal end 238 of interface 236. Consequently, a collection of one or more items placed on bottom plane 226a may tend to move towards origin 230 and be secured against both of side planes 226b, 226c, as well as against bottom plane 226a. The use of gravity in this manner may not only facilitate maintaining items in a particular arrangement, but may also facilitate obtaining dimensional information with a high degree of accuracy.

The size of three-plane resting device 224 may be configured as necessary for any particular application. In some embodiments, a packaging production machine that operates in connection with measurement system 202 may have a maximum template size that can be produced. In such a case, three-plane resting device 224 can be sized so as to allow items to be arranged therein and remain smaller than the maximum allowable template size. Alternatively, three-plane resting device 224 may have other sizes. For example, a person, company, or other entity that packages items may prefer that customized packages not exceed a particular size for any number of reasons (e.g.,, shipping costs, difficulty in assembly of packaging, etc.), and three-plane resting device 224 may be sized accordingly. Further, multiple three-plane resting devices 224 or other types of components of a measurement system may be used on a single packing line, any of which may have different sizes for use with different arrangements of to-be-packaged items, sizes of to-be-packaged items, and the like.

As noted previously, support structure 228 can be used to position planes 226a-c at a desired position, such as at a desired position relative to a horizontal support surface. To facilitate such an arrangement, support structure 228 may include a frame made of multiple horizontal and/or lateral components. For instance, support structure 228 of FIGS. 2A and 2B defines a frame having a set of vertical supports 240a-d and a set of horizontal supports 242a-d.

With regard to the illustrated embodiment, vertical supports 240a-d attach to corresponding horizontal supports 242a-d and to bottom plane 226a. In this embodiment, one or more of vertical supports 240a-d may have different lengths. For instance, vertical support 240a may have a length greater than a length of any of vertical supports 240b-d, while vertical support 240d may have a length less than either of vertical supports 240b, 240c. Vertical supports 240b, 240c may have about the same length, although this is not necessarily the case. By attaching bottom plane 226a to upper portions of vertical supports 240a-d, the different lengths of vertical supports 240a-d can cause bottom plane 226a to slope or incline in a desired manner. It will be appreciated however that support structure 228 may use other mechanisms to cause a desired incline, such as by causing a lower profile or thickness of bottom plane 226a to change, such that each of vertical supports 240a-d may be approximately the same length. In some embodiments support structure 228 may provide a support that does not incline in one or more directions, support structure 228 may include more or fewer than four vertical supports 240a-d, or even may be eliminated entirely.

While an inclined resting device is not necessary, the inclined three-plane resting device 224 can offer various desirable features. For example, as discussed previously, the slope on three-plane resting device 224 can facilitate alignment of items thereon. In particular, embodiments of a measurement system that includes a generally non-inclined surface may cause a user to be required to manually align one or more items in a manner that is time consuming in order to produce an accurate measurement. Three-plane resting device 224 can, however, use planes 226a-c together with the slope thereof to allow items to slide into place to more efficiently allow accurate measurements to be obtained. It should be appreciated, however, that it is not necessary that items freely slide relative to planes 226a-c. For instance, in one embodiment, a friction-enhancing coating or surface may be applied to one or more of 226a-c so as to engage arranged items and reduce the chance that such items will inadvertently move while measurement component 220 obtains desired dimensional information.

As further shown in FIGS. 2A and 2B, measurement system 202 can include a measurement component 220. Measurement component 220 may include any number of different types of devices or structures, and can facilitate obtaining of dimensional information of one or more items arranged using arrangement component 218. According to one example, for instance, measurement component 220 includes an imaging device 246, such as a three-dimensional scanner or camera, although any number of imaging or other devices can be used.

In this embodiment, imaging device 246 is extended relative to three-plane resting device 224 using an upright support 248. Imaging device 246 may have a lens or other imaging component that can view all or a portion of bottom plane 226a, and can be used to obtain measurements or other dimensional information of items arranged within three-plane resting device 224 (e.g., using origin 230 as a basis). For example, if one or more items are arranged on bottom surface 226a, imaging device 224 may measure or obtain data that can be used to calculate maximum length, width, and/or height information of the arrangement of items. For instance, a maximum length may be the maximum distance an arrangement extends in a direction normal to side plane 226b, while the maximum width may be the maximum distance an arrangement of items extends in a direction normal to side plane 226c. A maximum height may include the maximum distance the arrangement of items extends in a direction normal to bottom plane 226a.

Measurement component 220 and imaging device 246 may be varied in any number of ways. For example, according to one embodiment, imaging device 246 may be a time of flight camera. A time of flight camera can be used in some embodiments to provide a three-dimensional image by measuring or calculating the time it takes light to reflect of objects. A time of flight camera may be desirable for various reasons, but is not required for all applications. For example, a time of flight camera has recently become economically competitive to scanning and other camera technologies. Additionally, a time of flight camera can be used to gather real time information or other information very quickly and at a high degree of accuracy. For instance, all of the data points that create a point cloud used to determine dimensional data may be measured at the same time, thereby improving the speed over scanning technologies that measure only one point or area at a time and then compile the information together. One type of time of flight camera suitable for applications described herein is produced by IFM Efector. Such a camera may use time of flight principles to obtain a pixel-based image, with each pixel representing a time of flight measurement, and provide a digital, analog, or other.

Further, because items can be precariously stacked, a time of flight camera can measure all items at once, without having to move the objects or the sensor/scanner in relation to the others to produce a complete point cloud of dimensional data. An alternative solution contemplated within the scope of the present disclosure may e to align items in a particular manner, and then move a laser or other scanner around the items to obtain measurements, or move the items relative to the scanner itself. While this can be used to obtain item and arrangement measurements, a time of flight camera or other imaging device that obtains a full picture at one time, can simplify the mechanics needed to make the measurements, and may also make the process less expensive. A time of flight camera may thus provide significant savings in time and/or cost. Imaging device 246 may, however, be any other type of scanner, camera, imaging device, measurement tool, or the like that can be used to obtain image or dimensional information.

Imaging device 246 may directly calculate dimensional information, although in other embodiments imaging device 246 may provide data that is then aggregated by a separate component and used to determine the dimensional information. For instance, in FIG. 2A, imaging device 246 is connected to processing component 222. Processing component 222 may, for instance, receive data provided by imaging device 246 and combine the received data into a three-dimensional image (e.g., by using a software application, hardware, firmware, or any combination thereof to interpret the results). In other embodiments, imaging device 246 may be another type of camera or scanner, may use one or more laser beams to scan the arrangement and obtain dimension-related information, may use sonic, x-ray, sonar, or other technologies, or any combination of the foregoing.

In still another embodiment, measurement component 220 may include a mechanism for moving one or more of planes 226a-c, or other planes cooperating therewith. For example, additional movable panels may be placed opposite planes 226a-c. Such panels may be ride on a track or otherwise be manually or automatically movable. Once an arrangement of items is configured in a desired manner, the panels may be manually or automatically moved to engage distal ends of the arrangement. Based on the position of the panels, dimensional information related to the height, width, and length of the arrangement may be obtained or otherwise processed.

Whatever the type of measurement component 220 is used, measurement component 220 may obtain information related to the length, width, and/or height dimensions of the arrangement on resting device 224, although other information may also be obtained. For instance, measurement component 220 may identify curvatures of the arrangement for formulation of a curved package or a package of an irregular shape. Measurement component 220 may also obtain weight or other information. Once any such information has determined, measurement component 220 may communicate with processing component 222, so as to provide processing component 222 with information regarding the dimensions or other configuration of the arrangement of one or more items on resting device 224.

In FIG. 2A, measurement component 220 is shown as being coupled to processing component 222, and measurement component 220 may provide any obtained information to processing component 224. The information may be provided in any suitable manner. For example, in one embodiment, measurement component 220 is connected to processing component 222 by means of one or more wires (e.g., parallel or serial connections) or other physical connectors. In other embodiments measurement component 220 may be connected to processing component 224 using a wireless connection.

Processing component 222 may be used to analyze the information provided by measurement component 220, to send the information to a packaging production machine, to provide visual information to the operator arranging items on resting device 224, or for any other suitable purpose. For example, FIG. 2A illustrates processing component 222 as including a display device 250. Display device 250 may be used, by way of illustration, to display a user interface for providing information to a user and/or receiving instructions or other information from a user.

FIG. 2C illustrates in greater detail a user interface 252 according to merely one example embodiment of the present disclosure. Indeed, in some embodiments, no user interface may be provided. As shown in FIG. 2C, an exemplary user interface 252 may include any number of different types or arrangements of components. Each such component is optional, but can be provided to facilitate use of the measurement system 202 by a user.

In FIG. 2C, the graphical user interface may include a graphical representation 254 providing visual indicia representative of the arrangement of items on a resting device. Graphical representation 254 itself may also take any number of different forms. For instance, graphical representation 254 may be an image of the arrangement of items, an illustration of general dimensions, or include information. In one embodiment, graphical representation 254 includes an image of time of flight data retrieved by a time of flight camera.

In some cases, user interface 252 may also include textual or other elements. In FIG. 2C, for instance, user interface 252 includes textual information in the form of dimensional information 256. In particular, according to one aspect, dimensional information 256 is provided to indicate the length, width, and/or height of the arrangement of items on an arrangement component. Dimensional information 256 may include additional or other information as well. For instance, weight or volume information may also be included.

The dimensional information 256 may be provided on an ongoing, periodic, or on-demand basis. For instance, as items are arranged using the arrangement component 218, an imaging device may be constantly obtaining dimensional information 256, or may obtain such information at certain intervals. The communication between the imaging device and the processing component 222 may reflect such operation, such that dimensional information 256 may change constantly in the case of an imaging device operating constantly, or may change at particular intervals in the case of an imaging device that obtains information periodically.

In some cases, however, the imaging device may obtain dimensional data only upon request. For instance, user interface 252 includes an input 258 in the form of a measurement command button, although any suitable input may be used. A user may select the input 258, which can trigger a message sent to an imaging device, which then obtains dimensional information at a particular point in time. Thus, a user can control operation of the imaging device from user interface 252.

In other cases, input 258 may be used for other purposes. For instance, an imaging device may be operating continuously or periodically. Upon selecting input 258, the processing component may determine that the most recent dimensional data is the final data, and in response may send the final dimensional data to a packaging production machine.

User interface 252 optionally includes any number of other elements or features. As shown in FIG. 2C, for instance, in one embodiment user interface 252 may include a window or partition 260 that identifies different available packaging styles. Using window 260, a user may obtain information about different packaging styles that are available. Window 260 may also be used as an input in some cases, such as to allow a user to identify a particular type of packaging desired. In such a case, user interface 252 may also be used to calculate the design of a packaging template corresponding to the selected design and the determined dimensions, or may relay such selections to a packaging production machine. In some cases, the user can select between different packaging styles to determine differences that may exist in production based on the particular design. For instance, depending on the packaging design, and even where a package has generally a same overall size, one type of packaging template may have a higher or lower associated cost. By way of example, certain packaging styles may be more or less expensive than others in terms of assembly time, material costs, assembly costs, production time, and the like. Information about different options can, in some cases, be displayed at user interface 252 to allow the user to determine which box style may have a lower cost, higher protection value, or other feature. In some cases, the information may be used by a user to determine that an alternative arrangement of the items may be desired. Other information, such as a history window 262, may also be included to identify past information acquired and sent to a packaging production machine.

Returning now to FIG. 2A, when processing component 222 has accessed dimensional information—either as received directly from measurement component 220 or as determined by processing data received from processing component 222—the dimensional information may further be processed in any number of different manners. For example, as discussed herein, processing component 222 uses the information in one embodiment to design a box or other packaging template that may be produced by packaging production machine. Processing component 222 may then send a message to a packaging production machine that includes the template design, or sufficient information to allow the packaging production machine to determine what design to produce. In another embodiment, processing component 222 sends the dimensional information to a packaging production machine and allows the packaging production machine to design a suitable packaging template that has suitable dimensions for the arranged items.

While processing component 222 in FIG. 2A is illustrated as a general purpose computing device, it should be appreciated that this example is illustrative only, and is not necessarily limiting of the present disclosure. Processing component 222 may include any type of special or general-purpose computer as described herein. Indeed, as noted herein, processing component 222 may in some embodiments be integrated directly within measurement component 220 or a packaging production machine.

In addition, although the foregoing description describes measurement component 220 as obtaining dimensional information and providing such dimensional information to processing component 222, it will be appreciated that this is exemplary only. For example, in other embodiments, measurement component 220 may capture an image or obtain other data, but may not determine dimensional information. Captured data may instead be provided to processing component 222, and processing component 222 may determine the dimensions of the arrangement on resting device 224. In these or other embodiments, measurement component 220 essentially acts as a sensor that is connected to processing component 222. Further, while measurement component 220, processing component 222, and arrangement component 218 are illustrated as separate units, it will be appreciated in view of the disclosure herein that one or more of measurement component 220, arrangement component 218, and processing component 222 may be combined and/or eliminated. For example, imaging device 246 may be any suitable dimension data acquisition device, and optionally includes processing capabilities such that imaging device 246 provides the functions of measurement component 220 and processing component 222.

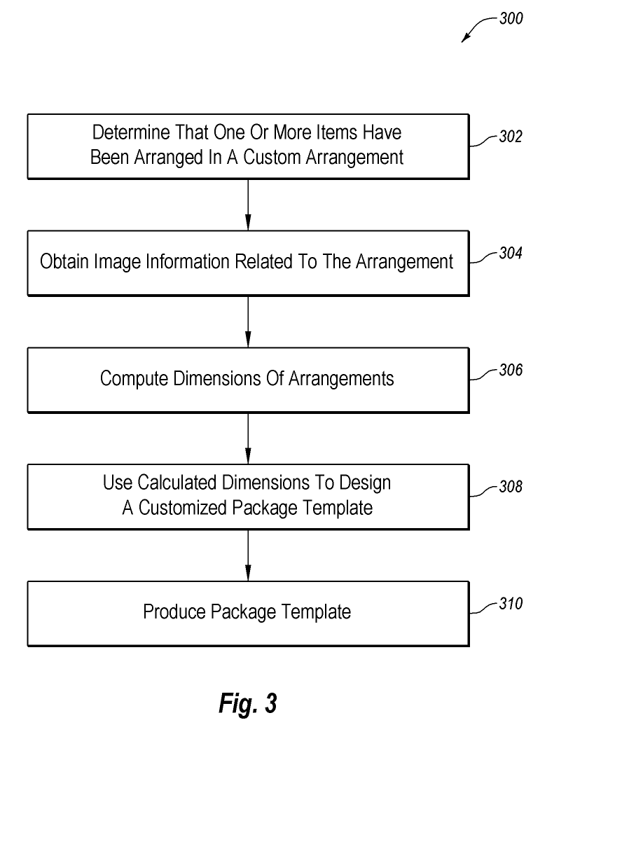

Turning now to FIG. 3, an exemplary method 300 of producing customized packaging is provided. As depicted, method 300 can include various optional acts and/or steps performed by one or more components of an on-demand customized packaging system. The acts and steps of method 300 will be described with respect to measurement systems 102 and 202, and packaging production machine 104 of FIGS. 1 and 2A, although such acts and steps may alternatively or additionally be performed by other components or systems.

As depicted in FIG. 3, method 300 includes an act of determining that one or more items have been arranged in a custom arrangement (act 302). For example, one or more items may be arranged on three-plane resting device 224 and measurement component 220 may detect the presence and/or position of the one or more items. Alternatively, an input such as a physical button or software-based button may be pressed by an operator of measurement component 220 and/or processing component 222 that requests a measurement of an arrangement of items, thereby indicating that a custom arrangement has been produced and that customized packaging is desired. Accordingly, determining that one or more items have been arranged in act 302 may indicate that items are currently being arranged, or that a final arrangement has been achieved, and/or that customized packaging is desired for the final arrangement.

Method 300 also includes an act of performing a three-dimensional scan of an arrangement (act 304). For example, in response to a user of measurement system 202 selecting input 258 within user interface 252 executing on processing component 222, processing component 222 may request that imaging device 246 capture a three-dimensional image or otherwise obtain three-dimensional data regarding an arrangement of items on resting device 224. Alternatively, imaging device 246 may operate in real-time, and can continually provide a three-dimensional scan of an arrangement of items, so that selection of input 258 or some other option merely selects data relevant to a scan at a particular point in time, but without expressly requesting that the scan be performed. The type of three-dimensional scan may vary based on the capabilities of imaging device 246 and/or measurement component 220. For example, a three-dimensional scan may include a full image of the arrangement, although any capture of information from which dimensional information (e.g., height, width, length) may be calculated may be properly considered a three-dimensional scan. Thus, a three-dimensional scan may occur at substantially a single point in time, without requiring measurements over different portions of the arrangement of items at different points in time.

Additionally, or alternatively, the dimensions of the arrangement of items may be calculated (act 306). For example, imaging device 246 may obtain an image (e.g., a scanned image made up of incremental images, or a single image obtained at one time) of the arrangement positioned on resting device 224. The image may be transmitted to processing component 222, which then executes one or more computer-executable instructions to interpret the image or other data, and to calculate the dimensional attributes of the arrangement on three-plane resting device 224. Of course, in other embodiments, measurement component 220 may directly obtain the dimensions of the arrangement of items, and act 306 may even occur as a part of scanning the arrangement in act 304. Accordingly, calculating the dimensions of the arrangement may be performed after or concurrent with the three-dimensional scan being performed, or without production of a three-dimensional scan.

Calculating the dimensions of the arrangement of items may also take other forms. For example, in one embodiment, a package may be damaged and it may be advantageous to re-package such items. A damaged package may have tears, holes, or may be partially crushed so that it has bulges. Regardless of the type of damage, the damaged package could be placed on resting device for alignment and measurement. A rectangular shape may be preferred for the package, and when the image is calculated, processing component 222 may take into account that the package is damaged. For example, imaging device 246 may obtain an image that identifies a bulge in the damaged package, and processing component 222 may determine the size of a box needed to package the items without the bulge. Thus, processing component 222 may calculate the dimensions of the image, and optionally modifies the dimensions to account for the package being damaged. The calculations may then be used to estimate a package template that can replace the damaged package, thereby allowing a new package template to be produced and the contents of the damaged package to be transferred to a new package.

Method 300 can also thus include designing the package template using the calculated dimensions (act 308). For example, a packaging production machine 104 may receive a message 106 from processing component 222 of measurement systems 102, 202, and message 106 may provide the dimensions of a customized arrangement of items manually, robotically, or otherwise placed in three-plane resting device 224 or some other type of measurement system 102. After receipt of such a message 106, packaging production machine 104 may automatically or upon request design a package template suitable to provide the desired dimensions. Such a package template may generally correspond to the dimensions received in message 106. The interior compartment of the package template may have dimensions configured to correspond exactly to those measured or calculated in act 306, although in other embodiments, a certain tolerance may be added to facilitate insertion of the arranged items in the package. Other changes to account for differences in internal vs. external dimensions of the customized packaging or other factors may also be considered.

Accordingly, in one embodiment, packaging production machine 104 may receive the packaging dimensions, and can then itself design the packaging template. Alternatively, measurement systems 102, 202 may design the packaging template. For example, upon calculating the dimensions, processing component 222 of measurement system 202 may design the packaging template and send the completed template design to packaging production machine 104 in message 106.

Designing the packaging template, whether performed by packaging machine 104, measurement systems 102, 202, or some other entity of an on-demand packaging system, may include looking-up a previously used template, or performing a new calculation for a template. For a new template, the new template may be designed automatically by packaging machine 104 or another component, such that the amount of corrugated cardboard or other material needed is automatically determined, along with the desired locations for cuts, creases, score lines, perforations, or other features that may facilitate assembly of the package from the template into a completed package suitable to receive and hold the items arranged in the scanned/imaged arrangement.

Any suitable manner for automatically and/or dynamically designing the template may be used. According to one embodiment, packaging machine 104 may have access to packaging materials 108 in the form of endless materials such as fanfold or rolled corrugated board. Such fanfold corrugated board may be accessible in a single size, or in multiple sizes. As such a design is being produced (e.g., by packaging machine 104 or processing component 222), the design itself may be optimized based on the available materials. Such optimization may take into account a desire to minimize use of the corrugated board or other materials given the different widths, sizes, or quantities of material that are available. Thus, measurement systems 102, 202 and/or packaging production machine 104 may consider different options for determining a near optimal packaging template that reduces the amount of corrugated board or other packaging materials that are used, or which factors in assembly or production time and costs.

Other requirements or factors may also be considered. For example, a package may have a minimum size restriction. This may be for any number of reasons, including a restriction due to the need to place a shipping label on a panel of the package. Additionally, automated tape sealers and gluing devices may have size restrictions that are considered in optimizing the package size and design. For example, a tape sealer may only operate with packages of certain aspect ratios without jamming. As further noted above, designing the package using the dimensional information may also include estimating dimensions of a package that can replace a damaged box.

Method 300 also includes an act of producing a package template (act 310). For example, based on a template design, packaging machine 104 may feed packaging materials 108 and cut or otherwise produce a template of a determined size and shape.

It will be appreciated in view of the disclosure herein that the method 300 provided herein may thus provide a method by which an order or request of specific items may be received, and from which a box template or other packaging template specific to those orders can be automatically or dynamically designed and/or produced, without the need for manual input of desired dimensions or the need to merely use an available package size and fill it with excess filler to protect the contents of the package. For example, after manual or other arrangement of items on resting device 224, and optionally provision of an indication that the arrangement has been completed, on-demand customized packaging system 100 may use method 300 to automatically scan and measure the arrangement, design a customized package, and produce a package template of the suitable size, optionally without any human intervention. Thereafter, the customized packaging may be assembled and then automatically or manually loaded with the identified to-be-packaged items placed in the package in the same arrangement used to obtain the dimensions for the customized package.

In still other embodiments, however, some human or other manual intervention may be desired before a packaging template is designed and produced. For example, in one embodiment, there are different available model arrangements for the to-be-packaged items, and each possibility may have different advantages. In some embodiments, an operator of system 100 may therefore provide some input as to which option should be selected for the customized packaging. For example, processing component 222 may identify different box templates that may be produced to provide desired dimensions for a precise fit of the arranged items. Such identification may be provided graphically, audibly, or otherwise and allow an operator to view or otherwise access information about the different packaging designs available, and to select from one of the available designs. The operator may potentially be provided a suitable rectangular design and a suitable cylindrical design, or otherwise be allowed to choose which template is desired for different sizes, shapes, and styles of packaging. Alternatively, different designs may be produced to use different amounts of corrugated board based on, for example, a particular style of packaging. While an operator may choose to minimize use of packaging materials, in other cases a weight, breakability, or other aspect of the arranged items may weigh in favor of using a more robust package style.

Alternatively, rather than prompt the user for a desired design or style for a package, the selection may be performed automatically (e.g., based on predetermined settings or preferences). For example, an administrator or operator may specify certain conditions under which specific types of boxes (e.g., rectangular vs. cylindrical, normal vs. heavy weight, etc.) should be used. Packaging machine 104 or measurement system 102 may then automatically select a design based on such predetermined settings or preferences.

Further, while the foregoing discussion relates largely to manual placement of items on resting device 224, this is exemplary only. In other embodiments, other types of resting devices may be used and/or arrangements may be made. By way of example, in one embodiment, a resting device may be a conveyor that carries a single material or multiple materials towards a packing line. Each item, or arrangement of items, may pass past a camera, scanner, or other imaging device that produces the dimensions thereof. When all items that are to be packaged together have been imaged, measurement system 102 may calculate the dimension of the overall arrangement of items. Calculating the dimension of the overall arrangement of items may include processor component 222 producing a virtual simulation or model of how the different objects can be arranged in a suitable manner. A processor component 222 performing in this manner may thus try multiple arrangements or use an algorithm that produces an optimal, or near optimal, arrangement of items that may be difficult or time-consuming for a person to manually reproduce. Once the optimal arrangement has been produced—either virtually or physically—the dimensions can be calculated and used to design a box template. Thus, even if an arrangement is virtual, the virtual arrangement may be produced based on images and actual real-time calculations of individual or groups of items. In the case of a virtual arrangement, processor component 222 may also produce instructions for the packing line to know how to arrange the items in the simulated manner.

Other times, purely manual arrangement of all items may be preferred. For instance, some objects may be flexible, may have voids into which other objects can be inserted, etc. These features may make automated arrangement more complicated. By way of illustration, a shirt that may be packaged with other items can be sufficiently flexible to allow the shirt to fit in any number of different spaces of different sizes and shapes. This flexibility may make automated determination of an optimal packaging solution difficult as there may not be any fixed size or shape to the shirt. Thus, in some cases, manual arrangement can be used to solve the “puzzle problem” that makes some simulations difficult.

Turning now to FIG. 4-8C, particular illustrations are provided to more clearly illustrate exemplary methods for arranging items and/or producing customized packaging based on customized arrangements. It will be appreciated that the example arrangements and packaging templates in FIGS. 4-8C are provided merely as generalized examples of items and packaging designs, and that other items, quantities of items, shapes of items, box shapes, box designs, and other features are contemplated within the scope of the present disclosure.

FIG. 4, illustrates an example collection of five items 401a-e that may be packaged together in any number of different custom arrangements, and then packaged in such arrangements. For example, a consumer may place an order requesting that each of items 401a-e be delivered to a particular destination. It may be difficult, if not impossible, to predict beforehand that any order will include exactly items 401a-e. As a result, it is likely that there is no packaging specifically developed to contain an arrangement of items 401a-e as precisely as desired. Accordingly, to provide packaging that allows for a precise fit to a specific arrangement of items 401a-c, and which may, for instance, reduce the risk of damage or loss to items 401a-e, a customized package may be developed (e.g., by using method 300 of FIG. 3).

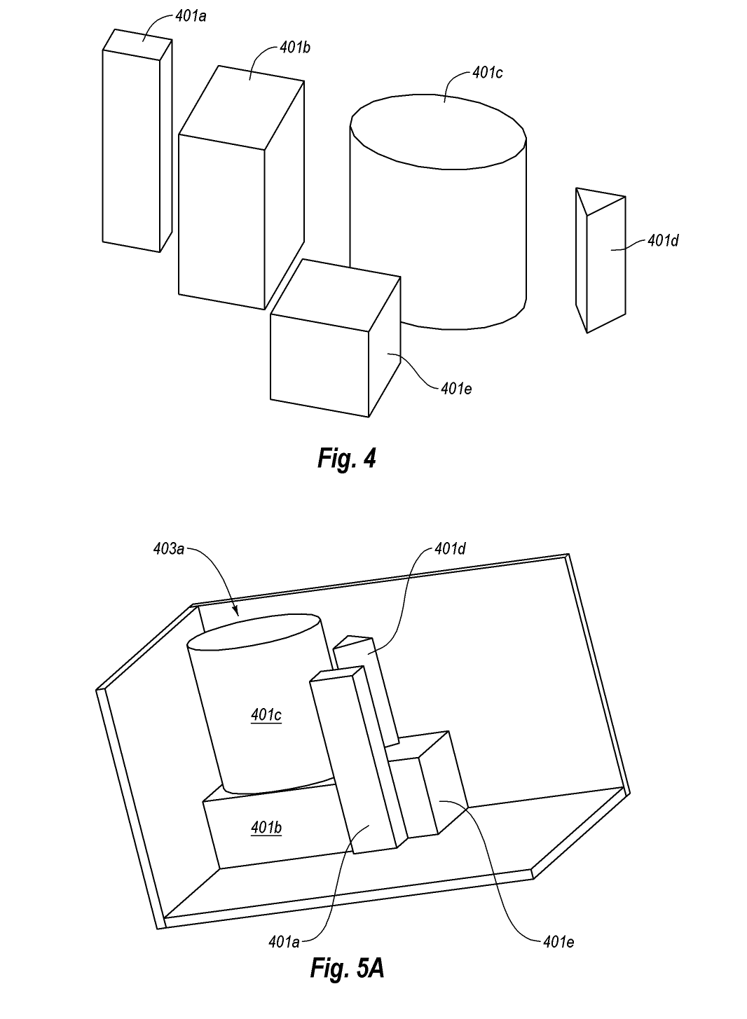

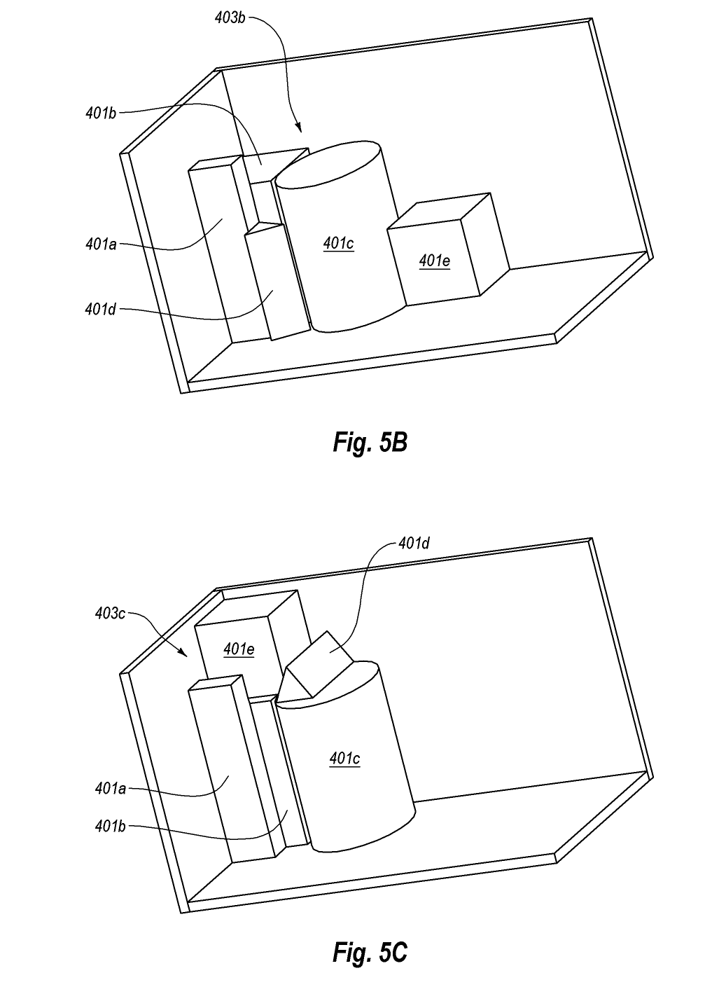

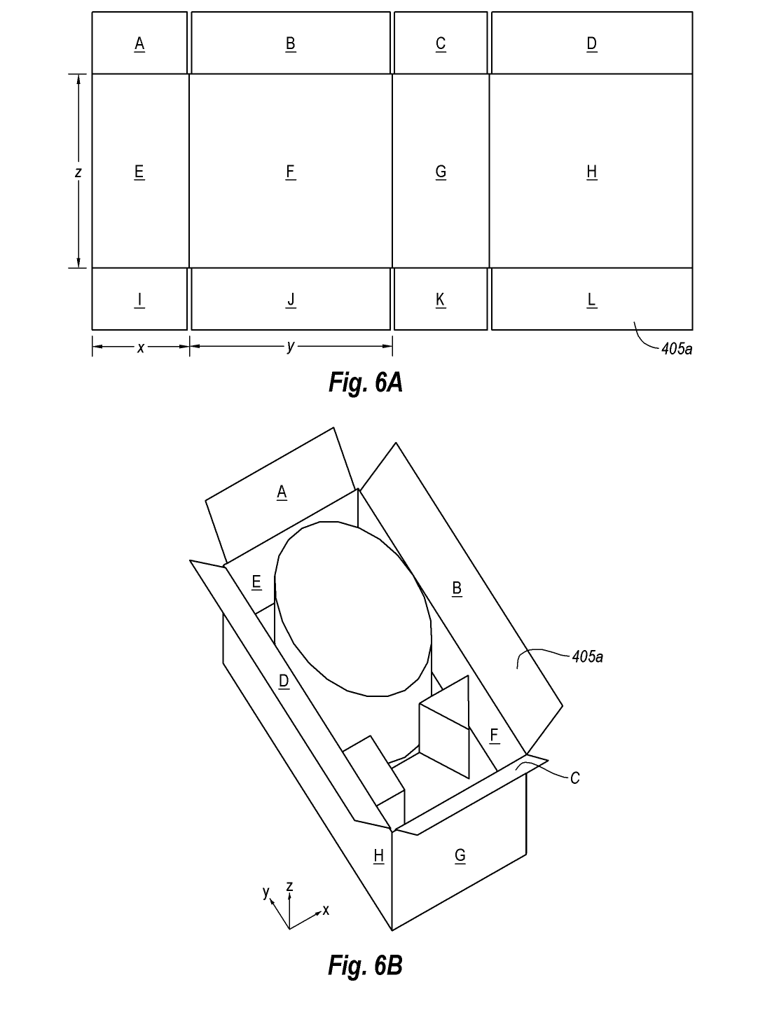

To produce the customized package, items 401a-e may be arranged in any of a number of different manners. For example, FIGS. 5A-5C each illustrate a different respective arrangement 403a-c that may be produced by, for example, manually arranging items 401a-e. Such items 401a-e may be arranged at any suitable location, including on a device similar to three-plane resting device 224 (FIG. 2A). Using method 300 of FIG. 3 or another suitable method for producing an on-demand customized package, box templates 405a-c of FIGS. 6A-8C may be produced. To further understand a manner in assembling box templates 405a-c, panels are labeled as A-L in an unassembled state, and with labels A-H in the assembled state, as corresponding panels I-L are illustrated on the bottoms of respective assembled packages 405a-c. Additionally, various dimensions related to the width (“x”), length (“y”), and height (“z”) are shown on the unassembled box templates 405a-c, as well as on the coordinate axes for assembled box templates 405a-c.

As will be appreciated in view of the arrangements of FIGS. 5A-5C and the box templates of FIGS. 6A-8C, any number of possible arrangements may be made of the same items (e.g., five items 401a-e), with each possible arrangement having individual dimensions that may be measured, calculated, or otherwise determined. Such dimensional information may then be used to produce a box template of a size corresponding to the particular arrangement of items.

Each arrangement may have a desirable or undesirable effect on the packaging to be created. For instance, each of arrangements 403a-c can have different combinations of length, width, and height dimensions. If the same general packaging design is used for each of arrangements 403a-c, the packaging templates can vary widely. As a result, the arrangement may have an effect on the cost of the packaging. For instance, some arrangements may increase the amount of packaging material used to produce a package template, while other arrangements may have a larger volume, thereby resulting in a potential increase in the amount of filler materials to be inserted in the package.

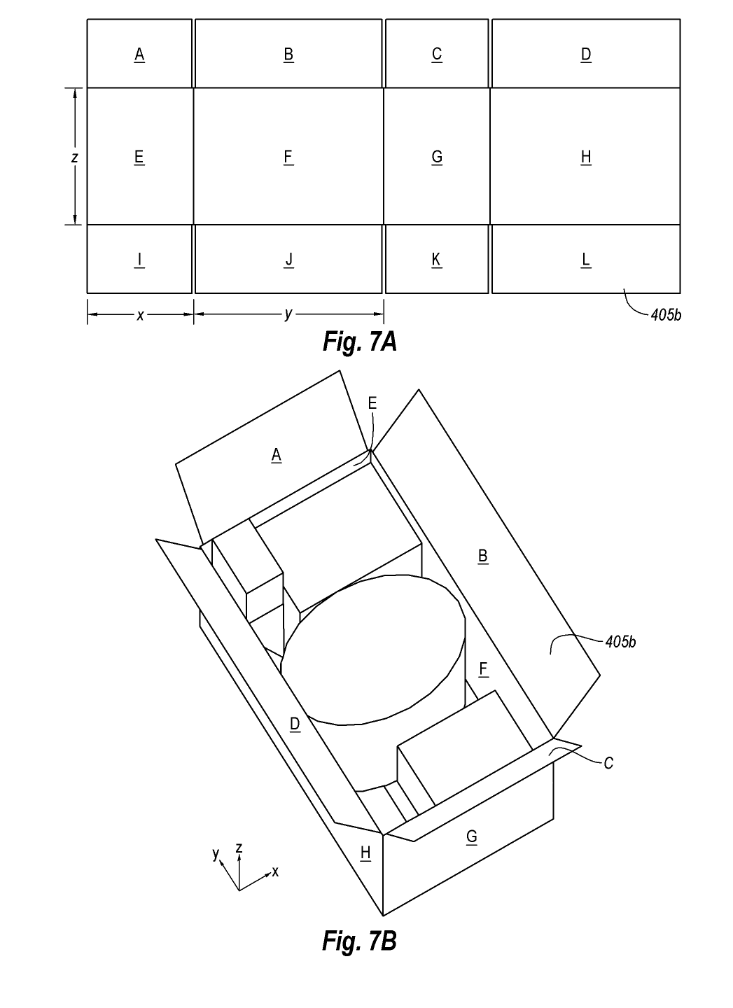

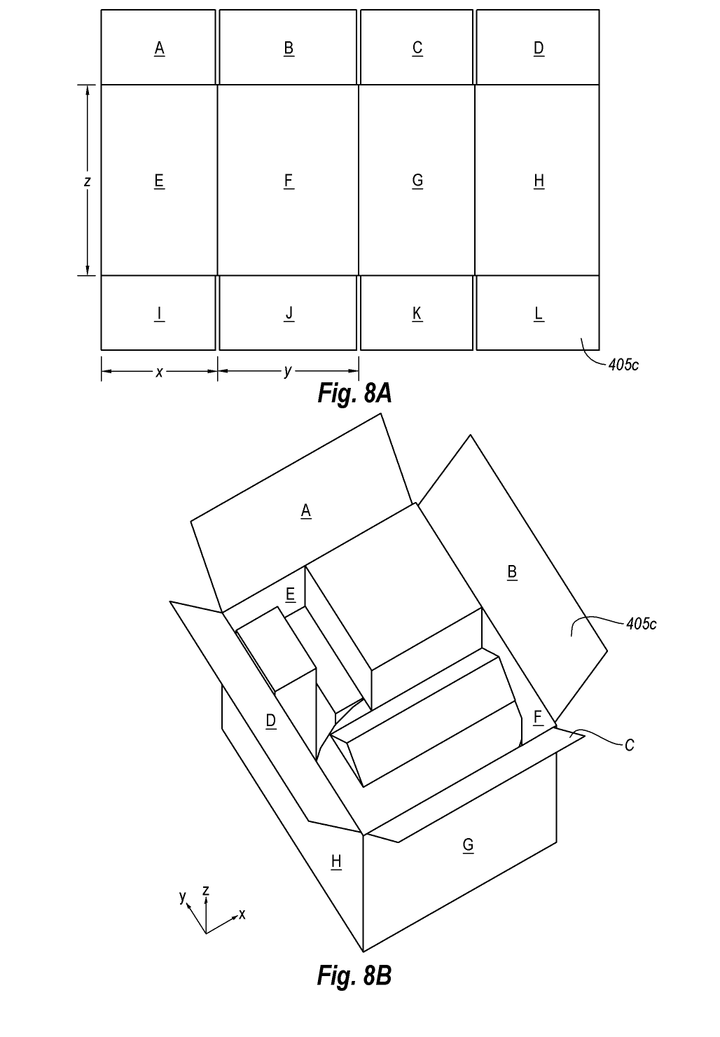

By way of illustration, an arrangement resulting in package template 405a of FIG. 6A or package template 405c of FIG. 8A may be determined to be superior to an arrangement resulting in package template 405b of FIG. 7A. For instance, based on the dimensions of items 401a-e and their arrangements, the package template 405b may require fourteen percent more packaging materials (e.g., corrugated cardboard) than either package template 405a, or 405b. Moreover, the volume of the assembled package template 405b is also significantly larger. In the illustrated embodiment, packaging template 405b has a volume at least thirteen percent greater than the volume of assembled template 405a or 405c, such that there may be an increase of at least thirteen percent in the amount of filler or interior packaging materials that are also used for producing template 405b.

As between packaging templates 405a and 405c of FIGS. 6A-8B and 8A-8B, the differences in material cost and volume may be considered marginal. For instance, in the illustrated embodiment, packaging template 405a may result in a lower packaging material cost, while packaging template 405c may result in a lower volume package. In particular, the packaging material savings for packaging template 405a are on the order of a half a percent, while the volume savings for packaging template 405c over template 405a are about one and a half percent. Thus, there is less space within box template 405c for items to shift about and potentially break, and thus a reduced need for interior packaging materials, although there is a corresponding increase in the amount of packaging materials needed to produce the actual template itself

As will be appreciated, the examples of templates 405a-c in FIGS. 6A-8B are merely exemplary of some of the possible templates that can be produced for arrangement of items 401a-e. Moreover, as different collections of items may also be arranged, an infinite number of arrangements and box templates may be produced on-demand using the systems, methods, and apparatus disclosed herein.

Accordingly, the efficiency and preciseness of packaging described herein may be limited only by the manual or robotic arrangement of items. For example, as discussed above with regard to FIGS. 6A-8B, a user may arrange items in any number of different ways, and may attempt to arrange the items in an optimal or near-optimal arrangement that provides a generally rectilinear form for insertion into a customized package. In some cases, the package may be customized for a particular size such that workers on a packing line do not need to select an oversized package that may either risk damage or loss to items or require additional internal packaging materials to reduce such risk.

While the foregoing discussion relates to customization of a box for a particular order or other collection of items, it should be appreciated that the described methods may also be readily adapted for other uses. For example, according to one embodiment, a measurement system may not be connected to a packaging production machine. When the items are arranged and measured, a portion of a measurement system (e.g., processing component 222) may access an information store that identifies what standard or pre-determined sized boxes are available. The measurement system may then make a recommendation on which standard sized box to use, so that workers on the packaging line need not guess at which package to use, and may instead use an already available box for a suitably precise package. In other embodiments, the measurement system may be connected to the packaging production machine, but may request a standard sized box rather than a customized box.

Accordingly, while one embodiment of the present disclosure is related to dynamically producing a package specifically customized to particular items, another embodiment relates to dynamically identifying which of a variety of already available boxes, or already designed boxes, is most appropriate for a collection of items.

The discussion herein refers to a number of methods and method steps and acts that may be performed. It should be noted, that although the method steps and acts may be discussed in a certain order or illustrated in a flow chart as occurring in a particular order, no particular ordering is necessarily required unless specifically stated, or required because an act is dependent on another act being completed prior to the act being performed.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “network” is defined as one or more data links that enable the transport of electronic data between computer systems and/or modules, engines, and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, carrier waves, wireless signals, and the like, which can be used to carry desired program code means in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices.

Those skilled in the art will also appreciate that embodiments of the present disclosure may be practiced in special-purpose or other computing devices integrated within or coupled to packaging machines, whether by a network connection, wireless connection, or hardwire connection. Exemplary packaging machines may include machines that cut or crease packaging materials to form packaging templates. Example packaging machines suitable for use with embodiments of the present disclosure may also directly, or indirectly, execute program code that enables the packaging machine to accept dimensional inputs and design a customized packaging template based on the input. Such input may be provided manually or, as described herein, may be provided by a packaging customization engine that, for example, automatically determines the dimensions necessary. In some embodiments, the packaging customization engine may also be incorporated within the packaging machine that cuts customized packaging templates, while in other embodiments it is separate from the packaging machine and communicatively coupled thereto.

Although the foregoing embodiments have been described in some detail by way of illustration and example, for purposes of clarity and understanding, certain changes and modifications will be obvious to those with skill in the art in view of the disclosure herein. The described embodiments are to be considered in all respects only as illustrative and not restrictive. Thus, all changes which come within the meaning and range of equivalency of the claims are to be embraced within their scope.

What is claimed is:

1. An arrangement and measurement system, comprising:
a resting element configured to receive and stabilize an arrangement of one or more physical items, said resting element including:
a base surface; and
at least one side surface connected to said base surface, wherein said at least one side surface and said base surface are oriented with respect to an origin; and
an imaging component, wherein said imaging component is configured to obtain dimensional information relative to said origin, said dimensional information being based on at least a size of said arrangement of said one or more physical items stabilized by said resting element.

2. The arrangement and measurement system recited in claim 1, wherein said at least one side surface includes at least two side surfaces, wherein each of said at least two side surfaces are generally perpendicular to said base surface, and wherein said base surface and said at least two side surfaces collectively intersect at said origin.

3. The arrangement and measurement system recited in claim 1, wherein said base surface is inclined in at least one direction.

4. The arrangement and measurement system recited in claim 1, wherein said base surface is inclined in at least two directions.

5. The arrangement and measurement system recited in claim 4, wherein said base surface is inclined in two directions towards said origin.

6. The arrangement and measurement system recited in claim 4, wherein said imaging component comprises a three-dimensional scanner.

7. The arrangement and measurement system recited in claim 6, wherein said three-dimensional scanner comprises a time of flight camera.

8. The arrangement and measurement system recited in claim 1, wherein said imaging component is communicatively coupled to a packaging production device, and wherein said imaging component is configured to transmit said dimensional information for use by said packaging production device.

9. The arrangement and measurement system recited in claim 8, wherein said imaging component is communicatively coupled to said packaging production device via a processing component.

10. The arrangement and measurement system recited in claim 8, wherein said packaging production device is configured to, upon receipt of dimensions of said arrangement of said one or more physical items, dynamically produce a package template having an interior size generally corresponding to said dimensions of said arrangement.

11. A method for creating customized packaging on demand and based on a size of physical items for placement in the customized packaging, the method comprising:
determining that one or more items have been placed into an arrangement on a resting device;
obtaining image data of said arrangement, said image data representing three-dimensional size information; and
in response to obtaining said image data, dynamically designing a package template having an interior capacity generally corresponding to said three-dimensional size information.

12. The method recited in claim 11, wherein obtaining image data of said arrangement includes:
using a three-dimensional scanner, obtaining images of said arrangement on said resting device.

13. The method recited in claim 11, further comprising:
using a processing component, using said image data to compute said three-dimensional size information.

14. The method recited in claim 11, further comprising:
using a packaging production machine in producing said dynamically designed package template from one or more packaging materials.

15. The method recited in claim 11, wherein said resting device comprises:
a three-plane resting device, said three-plane resting device defining an origin, and said obtained image data being oriented relative to said origin.

16. The method recited in claim 11, obtaining image data of said arrangement includes displaying, at a user interface, at least one of:
a visual representation of said image data; or said three-dimensional size information.

17. A system for measuring an arrangement of items for dynamic design and creation of a customized package, the system comprising:
a resting device configured to receive an arrangement of a plurality of physical items;
an imaging component, wherein said imaging component is configured to obtain image data of said arrangement of said plurality of physical items; and
a processing component operably coupled to said imaging component, said processing component being adapted to use said image data to obtain dimensional information related to said arrangement of said plurality of physical items.

18. The system recited in claim 17, further comprising:
a user interface, wherein said user interface is included with, or communicatively coupled to, said processing component, and wherein said user interface is configured to display at least a portion of said image data.

19. The system recited in claim 17, further comprising:
a packaging production machine communicatively coupled to said processing component, wherein said packaging production machine is configured to receive said dimensional information from said processing component and use said dimensional information in dynamically producing a packaging template of a size corresponding to said dimensional information.

20. The system recited in claim 19, wherein at least one of said processing component or said packaging production machine is configured to automatically, and without user dimensional input, design said packaging template that when assembled has an interior capacity generally corresponding to said dimensional information.

21. The system recited in claim 17, wherein said resting device comprises:
a three-plane guide, wherein said three-plane guide includes three interconnected planes oriented relative to an origin location,
wherein said imaging component is configured to obtain said image data relative to said origin location.
